(19) United States
(12) Patent Application Publication
(10) Pub. No.: US 2014/0172551 A1
(43) Pub. Date: Jun. 19, 2014

(54) Using Transaction Data and Platform for Mobile Devices

(71) Applicant: SAS INSTITUTE INC., Cary, NC (US)

(72) Inventors: Vijay S. Desai, San Diego, CA (US); Revathi Subramanian, San Diego, CA (US)

(73) Assignee: SAS Institute Inc., Cary, NC (US)

(21) Appl. No.: 13/719,695

(22) Filed: Dec. 19, 2012

(51) Int. Cl. G06Q 30/02

(52) U.S. Cl. CPC G06Q 30/0255
USPC 705/14.47; 705/14.53

(57) ABSTRACT

Systems and methods for using historical and current financial transaction data in implementing a marketing strategy are provided. A system and method can include updating stored signature data using current data associated with an entity. The signature data includes historic data including credit card transactions or debit card transactions associated with the entity. One or more model variables are generated using the updated signature data associated with the entity. A marketing score for the entity is determined by applying one or more model variables to a marketing model. The marketing score indicates a likelihood that the entity will respond to an offer. Whether the marketing score exceeds a predetermined marketing threshold is determined. Based upon determining that the marketing score exceeds the predetermined marketing threshold and determining that the entity is within the geographic area, an indication for triggering transmission of the offer to the entity is generated.

### TECHNICAL FIELD

The present disclosure generally relates to computer-implemented systems and methods for scoring transaction data using models in real-time.

### BACKGROUND

Marketing strategies can involve transmitting advertisements to mobile devices of entities. Systems and methods are desirable that can provide data on which advertisements can be selected for transmission.

### SUMMARY

In accordance with the teachings provided herein, systems and methods for using historical and current financial transaction data in implementing a marketing strategy are provided.

For example, a computer-implemented method can include updating stored signature data using current data associated with an entity and on a computing device. The signature data includes historic data including credit card transactions or debit card transactions associated with the entity. One or more model variables are generated using the updated signature data associated with the entity. A marketing score for the entity is determined, such as by applying one or more model variables to a marketing model. The marketing score indicates a likelihood that the entity will respond to an offer. Whether the marketing score exceeds a predetermined marketing threshold is determined. Based upon determining that the marketing score exceeds the predetermined marketing threshold and determining that the entity is within the geographic area, an indication for triggering transmission of the offer to the entity is generated.

In another example, a system is provided that includes a processor and a non-transitory computer-readable storage medium. The non-transitory computer-readable storage medium contains instructions which when executed on the processor cause the processor to perform operations. The operations include updating stored signature data using current data associated with an entity. The signature data is configured to include historic data including credit card transactions or debit card transactions associated with the entity. One or more model variables are generated using the updated signature data associated with the entity. A marketing score for the entity is determined, such as by applying one or more model variables to a marketing model. The marketing score indicates a likelihood that the entity will respond to an offer. Whether the marketing score exceeds a predetermined marketing threshold is determined. Based upon determining that the marketing score exceeds the predetermined marketing threshold and determining that the entity is within the geographic area, an indication for triggering transmission of the offer to the entity is generated.

In another example, a computer-program product tangibly embodied in a non-transitory machine-readable storage medium is provided that includes instructions that can cause a data processing apparatus to update stored signature data using current data associated with an entity. The signature data includes historic data including credit card transactions or debit card transactions associated with the entity. One or more model variables are generated using the updated signature data associated with the entity. A marketing score for the entity is determined, such as by applying one or more model variables to a marketing model. The marketing score indicates a likelihood that the entity will respond to an offer. Whether the marketing score exceeds a predetermined marketing threshold is determined. Based upon determining that the marketing score exceeds the predetermined marketing threshold and determining that the entity is within the geographic area, an indication for triggering transmission of the offer to the entity is generated.

The details of one or more embodiments are set forth in the accompanying drawings and the description below. Other features and aspects will become apparent from the description, the drawings, and the claims.

### BRIEF DESCRIPTION OF THE DRAWINGS

FIG. 1 shows an example of an environment that includes a data processing device that can communicate with other devices using a network.

FIG. 2 shows a block diagram of an example of the data processing device of FIG. 1.

FIG. 3 shows an example of a data flow diagram that includes processes for generating a marketing score for an entity.

FIG. 4 shows an example of a signature for an entity.

FIG. 5 shows a flow chart of an example of a process for using marketing scores.

FIG. 6 shows a data flow diagram with an example for using marketing models with other types of models.

FIG. 7 shows a flow chart of an example of a process for using a fraud score and a credit risk score with a marketing score in connection with a marketing strategy.

Like reference numbers and designations in the various drawings indicate like elements.

### DETAILED DESCRIPTION

Certain aspects include systems and methods for using current and historical financial transaction data in connection with selecting marketing offers for transmission to an entity in a real-time manner. Stored historical data associated with an entity can be updated with current, raw data associated with the entity. The updated data can be processed and scored to determine a marketing score for the entity. The marketing score can indicate a likelihood of the entity to respond to a marketing offer and can be used in implementing a marketing strategy to better select advertisements to be transmitted to the entity. A customer's preferences for products may drift over time. Using historical data, including the most recent historical data, and current data can be useful in deriving implied customer preferences on which a marketing strategy can be based.

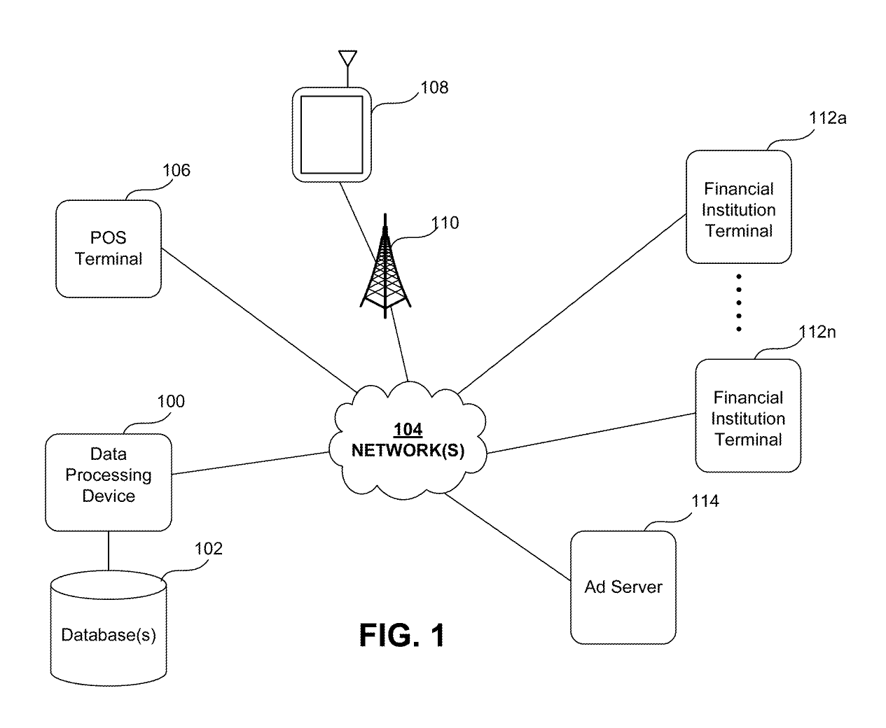

FIG. 1 is an example of an environment in which certain aspects may be implemented using a data processing device 100 coupled to a database 102. The database 102 can be a device that includes a non-transitory computer-readable memory on which data and code can be stored for access by the data processing device 100. Historical data associated with entities can be stored in the database 102. Historical data can include financial transaction data associated with entities. Examples of database 102 can include relational database management systems (RDBMS), or a multi-dimensional database (MDDB), such as an Online Analytical Processing (OLAP) database, etc. In some aspects, the data processing device 100 includes the database 102.

The data processing device 100 can communicate through one or more networks 104 with other devices, such as a point of sale (POS) terminal 106, a mobile device 108 through a wireless telecommunications system 110, different financial institution terminals represented by financial institution terminal 112a to financial institution terminal 112n, and an advertising server 114.

The POS terminal 106 may be a device located at a merchant. The POS terminal 106 can process financial transaction data in connection with the exchange of goods or services. For example, the POS terminal 106 can provide a payment request for a transaction associated with the entity, along with other transaction data, to the financial institution terminal 112a using the network 104. The financial institution terminal 112a may be a device at a financial institution, such as a credit card transaction processor. The financial institution terminal 112a can respond to the message from the POS terminal 106 with an authorization for payment or other appropriate responsive data. The financial institution terminal 112a can also provide the financial transaction data to the data processing device 100 using the network 104. The data processing device 100 can also receive location data about the location of the entity from, for example, the mobile device 108. In some aspects, the financial institution terminal 112a includes the data processing device 100.

The data processing device 100 can process the financial transaction data using the historical data from the database 102 to output an indication that is usable for selecting an advertisement to be sent to the entity. The entity, for example, may be in control of the mobile device 108 to which the advertisement can be transmitted in real-time or near real-time with respect to the transaction between the entity and the merchant associated with the POS terminal 106. The advertisement, for example, may be presented in text, audio, video, graphical data, electronic data, non-electronic data or some combination thereof.

In some aspects, the advertising server 114 can receive the indication from the data processing device 100, select an advertisement based on the indication, and transmit the selected advertisement to the mobile device 108 through the network 104. For example, the advertising server can decide the appearance of an advertising offer, even selecting from different appearances for an offer regarding a product. In other aspects, the advertisement may be provided to the entity through other channels, such as by email, telephone, or mail correspondence.

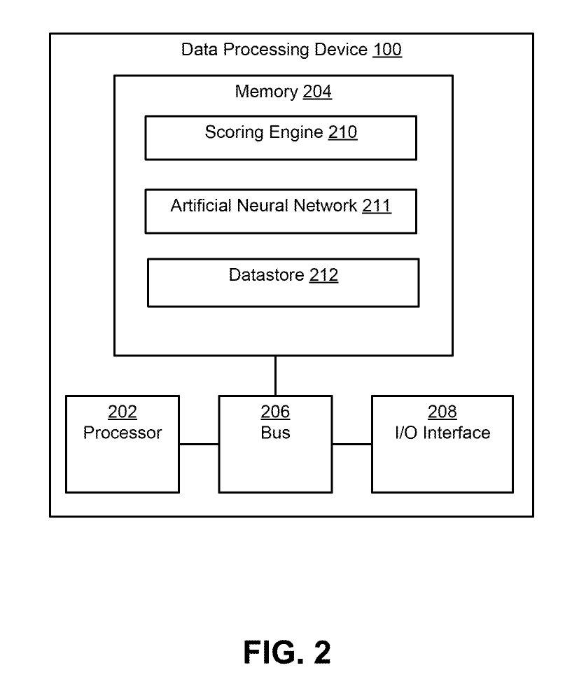

FIG. 2 depicts a block diagram with an example of the data processing device 100 according to one embodiment. Other embodiments may be utilized. The data processing device 100 includes a processor device 202 that can execute code stored on a tangible computer-readable medium in a memory 204, to cause the data processing device 100 to perform processes as described more fully herein. The data processing device 100 may be any device that can process data and execute code that is a set of instructions to perform actions. Examples of the data processing device 100 include a database server, a web server, desktop personal computer, a laptop personal computer, a server device, a handheld computing device, and a mobile device.

Examples of the processor device 202 include a microprocessor, an application-specific integrated circuit (ASIC), a state machine, or other suitable processor. The processor device 202 may include one processor or any number of processors. The processor device 202 can access code stored in the memory 204 via a bus 206. The memory 204 may be any non-transitory computer-readable medium configured for tangibly embodying code and can include electronic, magnetic, or optical devices. Examples of the memory 204 include random access memory (RAM), read-only memory (ROM), a floppy disk, compact disc, digital video device, magnetic disk, an ASIC, a configured processor, or other storage device. The bus 206 may be any device capable of transferring data between components of the data processing device 100. The bus 206 can include one device or multiple devices.

Instructions can be stored in the memory 204 as executable code. The instructions can include processor-specific instructions generated by a compiler and/or an interpreter from code written in any suitable computer-programming language. The instructions can include an application, such as scoring engine 210, that, when executed by the processor device 202, can cause the data processing device 100 to perform processes according to embodiments as explained in more detail below. Memory 204 can also include an artificial neural network 211 and a datastore 212. The artificial neural network 211 may be any mathematical model that is adaptive. An example of the artificial neural network 211 is a neural network employing Self-Organizing Neural Network Arboretum (SONNA) capability. The datastore 212 may be a relational database, a flat-file database, triplestore, or other data storage device.

The data processing device 100 can share data with additional components through the I/O interface 208. The I/O interface 208 can include a USB port, an Ethernet port, a serial bus interface, a parallel bus interface, a wireless connection interface, or any suitable interface capable of allowing data transfers between the data processing device 100 and another device. The additional devices can communicate with I/O interface 208 over a network or directly.

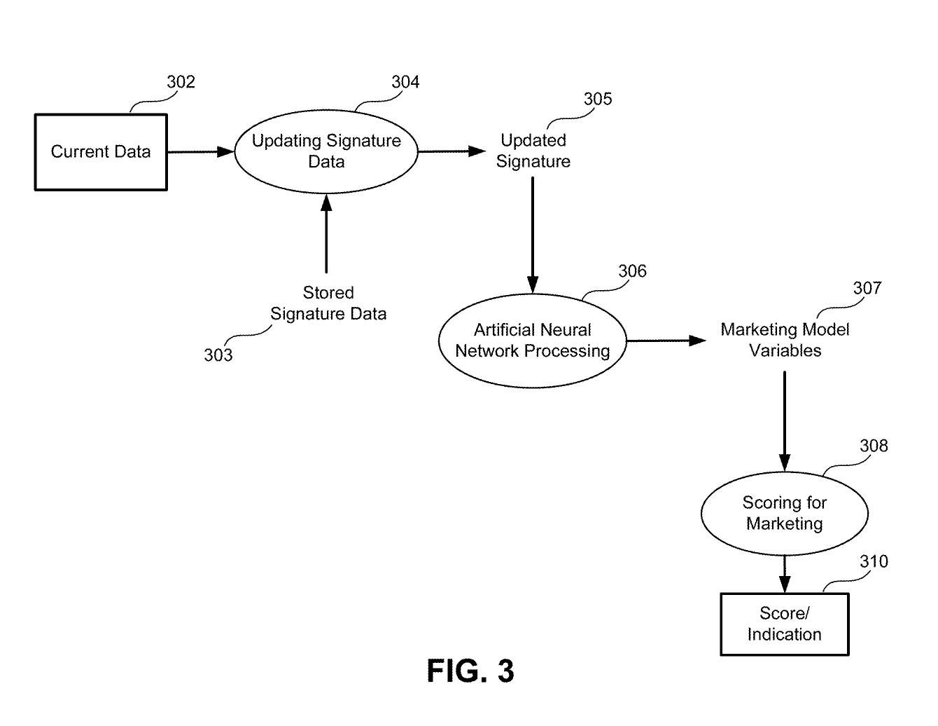

FIG. 3 is a data flow diagram that depicts an example of certain processes that can be performed by the data processing device 100 of FIG. 2.

As shown in FIG. 3, the data processing device 100 uses current data 302 and stored signature data 303 in a process of updating signature data 304. Current data 302 can include transaction data about the current transaction involving the entity, along with other data associated with the entity. The entity may be a person or business. The other data may include a current location of the entity. In some aspects, the transaction data is raw data. Raw data may be the actual received transaction data as compared to aggregated, derived, summarized, or averaged data. Transaction data can include an account number or an entity name, a time and a date of purchase, an amount of transaction, a merchant category code, a merchant zip code, and other types of data.

The stored signature data 303 is historical data associated with the entity and is stored in a signature in database 102, for example. A signature may be, for example, an account-level compilation of historical data of all transaction types. One signature record may be stored for each account (e.g., credit card account, debit card account, mobile telephone number account, etc.). Signature data can be updated with every new transaction received. Examples of types of signature data include a transaction date, a transaction time, an amount of transaction, a merchant category code, and a merchant zip code. A signature can include fields that store data of different types and/or for a certain length of time. For example, a raw data associated with a select number of transactions involving the entity can be stored as signature data. The select number of transactions may be a selected number of the most recent transactions involving the entity.

The signature data can be updated, for example, by removing the oldest data in a relevant field and adding relevant types of current data to a relevant field in a relevant signature. The length of time that a particular type of signature data is stored in the signature may vary based on the type of data. As an example, data about the merchant zip code and data about the transaction date for transactions may be stored longer in the signature than data about the transaction time for the same transactions. The length of time that a certain type of signature data is stored for one entity may be different than for another entity. For example, fifteen generations of a type of signature data may be stored for a first entity, while only six generations of the same type of signature data may be stored for a second entity that uses its associated account less frequently than the first entity uses its associated account.

Different types of data may be stored for signatures associated with the same account, but for different purposes. For example, a signature associated with an account for use in connection with determining a credit risk associated with the account may include different types of signature data stored for different lengths of time as compared to a signature associated with the account for use in connection with determining fraud on the account or for marketing purposes.

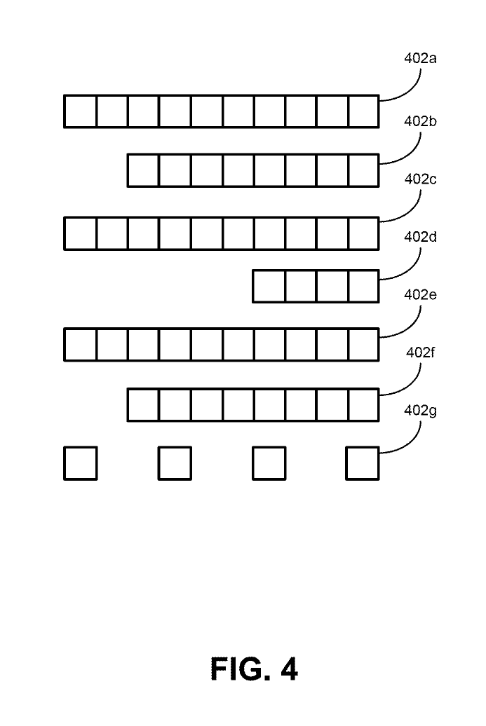

FIG. 4 depicts an example of a signature according to one embodiment. The signature includes records 402a-g and each of the records 402a-g corresponds to a different type of signature data. Each of the records 402a-g includes a selected number of fields in which signature data can be stored. The number of fields may be representative of the length of time a particular type of data is stored. For example, record 402a includes ten fields, which can represent that the signature data of a type associated with record 402a for the last ten transactions to be stored in the record 402a. Record 402d includes four fields, which can represent that the signature data of a type associated with record 402d for the last four transactions to be stored in the record 402d.

Returning to FIG. 3, the data processing device 100 processes the updated signature 305 using an artificial neural network 306. The artificial neural network can process the updated signature 305 to generate marketing model variables 307. Marketing model variables 307 may be information derived from the signature data and related (or potentially related) to factors associated with marketing. Examples of marketing model variables 307 include the distance of the current location of the entity from an address, such as the home address of the entity, the frequency of past purchases from merchant zip codes near a current location, an average amount of purchases from one or more zip codes near a current location, day of week and time of day purchase behavior on the current day compared to the entity's typical behavior prior to the current day and compared to purchase behavior of peers of the entity.

The data processing device 100 scores the marketing model variables 307 for marketing in a process 308 that results in a score or other indication 310. The marketing model variables 307 can be processed using models. A model may be an algorithm or other operation to which the data processing device 100 applies the marketing model variables 307. In some aspects, the model may be a predictive model that that can be developed in a testing or development phase prior to being used in a production phase. U.S. Pat. No. 7,788,195 to Subramanian, et al., issued Aug. 31, 2010 and titled “Computer-Implemented Predictive Model Generation Systems and Methods,” describes generating predictive models and is incorporated herein by reference.

In implementing a marketing strategy, the data processing device 100 can further process the score or other indication 310. Alternatively, the score or other indication 310 can be outputted to another device for triggering transmission of an offer to the entity or otherwise implementing a marketing strategy. The score or other indication 310 may be generated or outputted when the current location of the entity indicates that the entity is within a selected geographical area. In some aspects, the current location can be provided with the score or as part of the indication and is usable, along with the score, in selecting a type of advertisement to provide to the entity. The score or other indication 310 may be multiple scores, each score corresponding to an advertising offer, generated by applying multiple marketing models to model variables. In some aspects, the score or other indication 310 triggers the data processing device 100 to transmit the offer to the entity. In other aspects, the data processing device 100 can transmit an offer to the entity without having to first generate the indication for the offer.

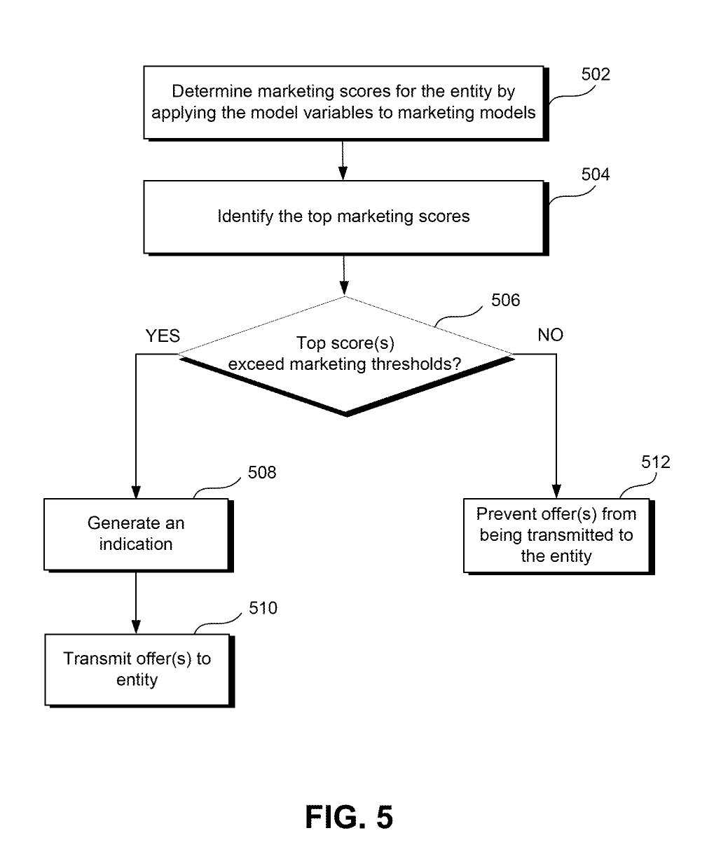

FIG. 5 depicts a flow chart with an example of the scoring for marketing process 308 in FIG. 3. In block 502, the data processing device 100 determines marketing scores for the entity associated with the signature by applying the model variables generated from signature data to marketing models. Various marketing models can be used, each including different variables in which certain model variables are applied, to output different marketing scores. For example, one model may output a score indicative of the likelihood that the entity will respond to an offer for a luxury item while another model may output a score indicative of the likelihood that the entity will respond to an offer for a household good in a certain zip code. In some embodiments, the number of scores correspond to the number of offers from which one (or more than one) is selected for transmission to the entity. For example, if ten thousand product advertisements are available, ten thousand scores can be determined from marketing models.

In some aspects, the data processing device 100 accesses marketing models stored in datastore 212 or database 102, applies the model variables to the marketing models, and executes the marketing models to which the model variables are applied. The output of executing the marketing models includes scores, which may be numeric values, letters on a graded scale, or other codes that are representative of the relative likelihood that the entity will respond to associated marketing offers.

In block 504, the data processing device 100 identifies the top marketing scores. In some aspects, the data processing device 100 executes a sorting algorithm, such as a “river sort” algorithm, to determine the top scores, which may include the top score, the top three scores, the top ten scores, etc.

In decision block 506, the data processing device 100 determines whether one or more of the top scores exceed a marketing threshold. The marketing threshold may be a pre-selected value or range that, based on statistical data about consumer behavior and the score format used by the data processing device 100, separates score levels that indicate the entity is unlikely to respond to a marketing offer and score levels that indicate the entity is likely to respond to a marketing offer. In some aspects, different marketing thresholds are used depending on the planned marketing strategy and for different scores. For example, one marketing strategy involving an advertisement for a household good may be associated with a lower marketing threshold than another marketing strategy involving an advertisement for a luxury item. The data processing device 100 may receive a command from a marketing customer for the pre-selected marketing threshold levels.

If one or more of the scores exceed the marketing threshold, the data processing device 100 generates an indication in block 508. The indication may be any indicator that represents that the entity is likely to respond to a marketing offer. The indication can also include additional information such as a code representing the entity, the current location of the entity, and the advertisements or other offers associated with the scores that exceed the marketing threshold. In block 510, the data processing device 100 transmits or causes to be transmitted an offer to the entity. In some aspects, the data processing device 100 includes stored contact information (e.g., cell phone number, email address, home address, etc.) for the entity and uses the stored contact information to formulate a message to the entity that includes the marketing offer. In other aspects, the data processing device 100 outputs the indication to another device, such as an advertisement server, that selects an offer from those associated with scores in the indication, and transmits the offer to the entity. In other aspects, the indication including the top scores is provided to an advertising server without being compared to a marketing threshold.

If the data processing device 100 determines that none of the top scores exceed the marketing threshold, the data processing device prevents an offer from being transmitted to the entity in block 512.

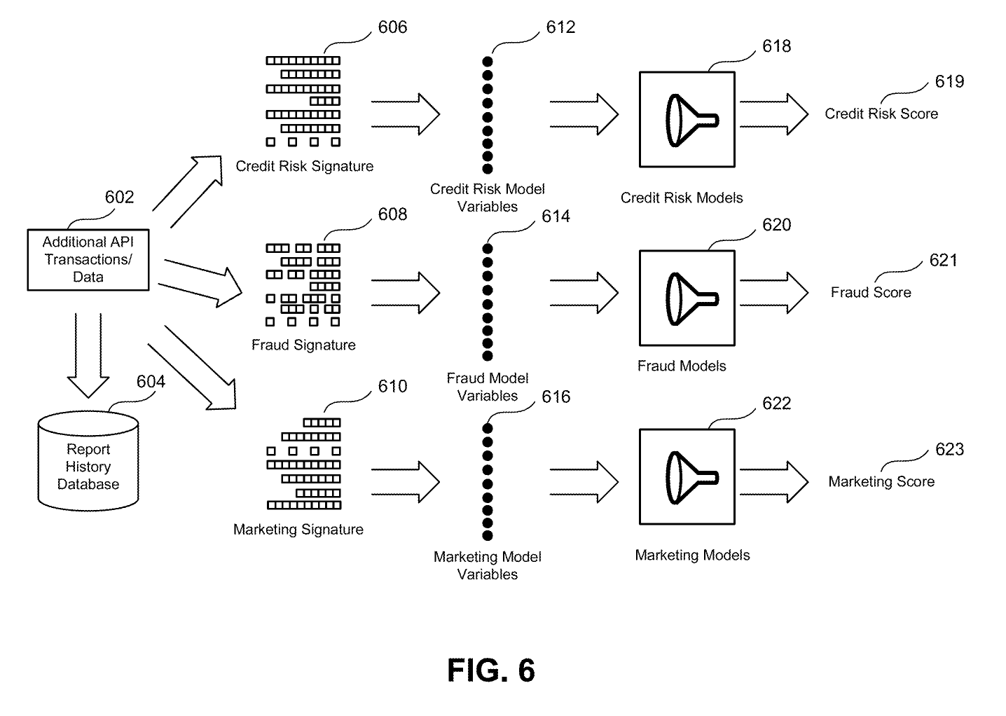

In some aspects and embodiments, other types of scores—such as credit risk scores and fraud scores—can be used with the marketing scores. FIG. 6 is a data flow diagram with an example of processes for generating additional types of scores, along with a marketing score, according to one embodiment. A system, such as a system including data processing device 100, can receive transaction and other types of data as represented by additional API (application programming interface) transactions/data 602. An API may be used that is flexible and is able to receive many different types of data, including credit card and debit card transaction data. Credit card and debit card transaction data includes any data associated with a financial transaction, including transactions involving payment using electronic payment methods. The API can also be expanded to receive Global Positioning System (GPS), IP address, multilateration triangulation data, software on the mobile device, SIM card, a combination of these types of data, or other types of location data. The system can store the data, as represented by the report history database 604, and can use the data and historic data to generate different types of signatures. The report history database 604 may be one of the databases 102 in FIG. 1 or datastore 212 in FIG. 2. Information on product purchasing behavior can be extracted from the report history database 604 and used to formulate signatures.

The different types of signatures in FIG. 6 include a credit risk signature 606, a fraud signature 608, and a marketing signature 610. The signatures may include records of different types and with different numbers of fields in which signature data can be stored. For example, a credit risk signature 606 may store ten generations of a record for one type of signature data, while the fraud signature 608 may store five generations, and the marketing signature 610 may store three generations, of the same type of signature data. In some aspects, the signature can store a superset of all fields in the various types of signatures. For example, if the last ten authorizations and the last six payments are used for credit risk purposes, the last twenty authorizations and the last three payments are used for fraud risk purposes, and the last thirty authorizations and no payments are used for marketing purposes, the signature can store the last thirty authorizations and the last six payments.

The system can generate model variables from each of the signatures. From the credit risk signature 606, the system can derive credit risk model variables 612. From the fraud signature 608, the system can derive fraud model variables 614. From the marketing signature 610, the system can derive marketing model variables 616. Model variables of different types may include different information derived from the respective signatures.

The system can apply each of the model variable types to respective models to generate scores. The system can apply the credit risk model variables 612 to credit risk models 618 to generate a credit risk score 619 that may be indicative of the relative credit risk associated with the entity. The system can apply the fraud model variables 614 to fraud models 620 to generate a fraud score 621 that may be indicative of the likelihood that the entity has been the victim of fraudulent charges or similar misdeeds. The system can apply the marketing model variables 616 to marketing models 622 to generate a marketing score 623.

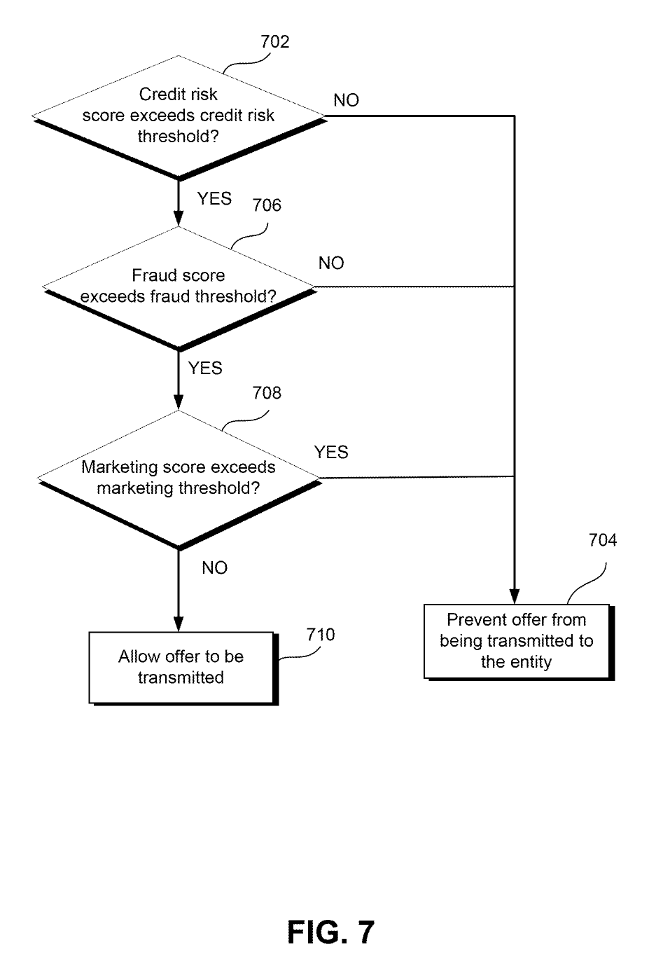

FIG. 7 depicts a flow chart with an example of a process for using the scores to determine whether to transmit an offer to the entity according to one embodiment. In decision block 702, the system determines whether the credit risk score exceeds a credit risk threshold. The credit risk threshold may be a level above which the scores indicate that the entity will likely be a credit risk. If the credit risk score exceeds the credit risk threshold, the system can prevent the offer from being transmitted to the entity, as in block 704. For example, the system can output no indication to another system that is configured for transmitting marketing offers in response to the indication or the system can stop processing in connection with the entity, at least for a certain amount of time.

If the credit risk score does not exceed the credit risk threshold, the system determines whether the fraud score exceeds a fraud threshold in decision block 706. In some aspects, the fraud threshold is a level above which the scores indicate that the entity has likely been the victim of fraud. If the fraud score exceeds the fraud threshold, the system can prevent the offer from being transmitted to the entity, as in block 704.

If the credit risk score does not exceed the credit risk threshold and the fraud score does not exceed the fraud threshold, the system determines whether the marketing score exceeds a marketing threshold, such as using a similar process as described with respect to decision block 506 in FIG. 5. If the marketing score does not exceed the marketing threshold, the system can prevent the marketing offer from being transmitted to the entity in block 704.

If the marketing score exceeds the marketing threshold, the system can allow the offer to be transmitted in block 710, such as by transmitting the offer to the entity or outputting an indication to another system to output the offer.

Decision blocks 702, 706, and 708 can be implemented in any order, and one or more of the decision blocks 702 can be implemented without implementation of all of the decision blocks. For example, the system may determine whether the fraud score exceeds a fraud threshold, and if so determine whether the marketing score exceeds the marketing threshold, without determining whether the credit risk score exceeds the credit risk threshold.

In other embodiments, the thresholds and score ranges are configured such that the system prevents offers from being transmitted when a fraud score and/or a credit risk score do not exceed thresholds and allow the offer to be transmitted when the fraud score and/or the credit risk score exceed the thresholds.

The following describes one example of using one aspect of the disclosed subject matter.

A data processing device receives from a POS terminal a transaction date, a transaction time, an amount of transaction, the merchant category code, merchant zip code, and account information, all associated with transaction between a person—the account owner—and a grocery store that is the merchant. The device associates the information with historical data for the account and updates a signature for the account. From the signature data, the device derives model variables that include: (1) the person is shopping at a location that is close to a home address of the person; (2) the person is shopping at a typical day and time for the person to shop; and (3) the person is likely a stay-at-home parent based on the typical day and time that the person shops and the merchants with which the person typically transacts business.

The system applies the model variables to a marketing model that involves weighting certain variables regarding consumer behavior in the relevant zip code in connection with a local coffee shop that is close to the grocery store. The output of the model is a marketing score that indicates the likelihood that the person would respond to (or at least be receptive to receiving) an offer from the local coffee shop. The device compares the marketing score to a threshold and determines that the person would likely be receptive to the offer from the local coffee shop. In response to detecting a current location of the entity, the device transmits the offer to a mobile phone associated with the person substantially in real-time with respect to the transaction between the person and the grocery store and/or detecting the current location of the entity.

A current location of the entity can be detected using any suitable mechanism or data. For example, a position of a mobile device associated with the entity can be detected or estimated using multilateration, triangulation, GPS, or other technique by a localization-based system, including a network-based system, a handset-based system, a SIM-based system, and a hybrid positioning system (e.g., Google Lattitude). A signal or other data representing the position (or estimated position) of the mobile device can be used as the location of the entity. A data processing device detecting the location of the entity within the geographical area can receive data from a location process that may be executed or performed by the data processing device or any device on or within a network, including a combination of servers, mobile devices, network components such as transmitters and receivers, etc. The location process can include IP address detection, multilateration, triangulation, execution of an application on a mobile device, and/or SIM card location.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus.

The computer readable medium can be a machine readable storage device, a machine readable storage substrate, a memory device, a composition of matter effecting a machine readable propagated communication, or a combination of one or more of them. The term “data processing device” encompasses all apparatus, devices, and machines for processing data, including by way of example a programmable processor, a computer, or multiple processors or computers. The device can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code), can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., on or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and a device can also be implemented as, special purpose logic circuitry, e.g., an FPGA (field programmable gate array) or an ASIC.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of nonvolatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) to LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any from, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims. For example, the actions recited in the claims can be performed in a different order and still achieve desirable results.

What is claimed is:

1. A computer-implemented method, comprising:
updating, on a computing device, stored signature data using current data associated with an entity, wherein the signature data includes historic data including credit card transactions or debit card transactions associated with the entity;
generating one or more model variables using the updated signature data associated with the entity;
determining a marketing score for the entity, wherein determining includes applying the one or more model variables to a marketing model, and wherein the marketing score indicates a likelihood that the entity will respond to an offer;
determining whether the marketing score exceeds a predetermined marketing threshold;
determining whether the entity is within a geographic area; and
based upon determining that the marketing score exceeds the predetermined marketing threshold and determining that the entity is within the geographic area, generating an indication for triggering transmission of the offer to the entity.

2. The method of claim 1, wherein generating the indication is done in real-time.

3. The method of claim 1, further comprising:
determining a fraud score for the entity, wherein determining the fraud score includes applying the one or more model variables to a fraud model;
determining that the fraud score exceeds a predetermined fraud threshold; and
based upon determining that the fraud score exceeds the predetermined fraud threshold, preventing transmission of the offer to the entity.

4. The method of claim 1, further comprising:
determining a credit risk score for the entity, wherein determining the credit risk score includes applying the one or more model variables to a credit risk model;
determining that the credit risk score exceeds a predetermined credit risk threshold; and
based upon determining that the credit risk score exceeds the predetermined credit risk threshold, preventing transmission of the offer to the entity.

5. The method of claim 1, wherein the signature data includes one or more fields that store raw transaction data associated with a select number of transactions involving the entity, and wherein the raw transaction data includes at least one of a transaction date, a transaction time, a transaction amount, a merchant category code, and merchant location data.

6. The method of claim 1, wherein generating the one or more model variables includes using other data associated with the entity.

7. The method of claim 6, wherein the other data includes an address, or a distance between an address and a current location.

8. The method of claim 6, wherein the other data includes a frequency of past purchases within a geographical area proximate to a current location.

9. The method of claim 6, wherein the other data includes an average amount of purchases within a geographical area.

10. The method of claim 1, wherein the current data associated with the entity is determined using a Global Positioning System.

11. The method of claim 1, further comprising:
detecting a location of the entity within the geographic area.

12. The method of claim 11, wherein detecting the location of the entity within the geographic area uses data from a location process including at least one of IP address detection, multilateration, triangulation, execution of an application on a mobile device, or SIM card location.

13. The method of claim 1, further comprising:
transmitting the offer to the entity.

14. The method of claim 1, wherein determining the marketing score for the entity includes determining multiple marketing scores by applying the one or more model variables to a plurality of marketing models, the method further comprising:
identifying a subset of scores from the multiple marketing scores as top scores that are compared to the predetermined marketing threshold.

15. A system, comprising:
a processor;
a non-transitory computer-readable storage medium containing instructions which when executed on the processor cause the processor to perform operations including:
updating stored signature data using current data associated with an entity, wherein the signature data is configured to include historic data including credit card transactions or debit card transactions associated with the entity;
generating one or more model variables using the updated signature data associated with the entity;
determining a marketing score for the entity, wherein determining includes applying the one or more model variables to a marketing model, and wherein the marketing score is configured to indicate a likelihood that the entity will respond to an offer;
determining whether the marketing score exceeds a predetermined marketing threshold;
determining whether the entity is within a geographic area; and
based upon determining that the marketing score exceeds the predetermined marketing threshold and determining that the entity is within the geographic area, generating an indication for triggering transmission of the offer to the entity.

16. The system of claim 15, further comprising instructions configured to cause the processor to perform operations including:
determining a fraud score for the entity, wherein determining the fraud score includes applying the one or more model variables to a fraud model;
determining that the fraud score exceeds a predetermined fraud threshold; and
based upon determining that the fraud score exceeds the predetermined fraud threshold, preventing transmission of the offer to the entity.

17. The system of claim 15, further comprising instructions configured to cause the processor to perform operations including:
determining a credit risk score for the entity, wherein determining the credit risk score includes applying the one or more model variables to a credit risk model;
determining that the credit risk score exceeds a predetermined credit risk threshold; and
based upon determining that the credit risk score exceeds the predetermined credit risk threshold, preventing transmission of the offer to the entity.

18. The system of claim 15, wherein generating the indication is configured to be done in real-time.

19. The system of claim 15, further comprising instructions configured to cause the processor to perform operations including:
detecting a location of the entity within the geographic area.

20. The system of claim 19, wherein detecting the location of the entity within the geographic area uses data from a location process including at least one of IP address detection, multilateration, triangulation, execution of an application on a mobile device, or SIM card location.

21. The system of claim 15, wherein the signature data is configured to include one or more fields that store raw transaction data associated with a select number of transactions involving the entity, and wherein the raw transaction data includes at least one of a transaction date, a transaction time, a transaction amount, a merchant category code, and merchant location data.

22. The system of claim 15, further comprising instructions configured to cause the processor to perform operations including:
transmitting the offer to the entity.

23. The system of claim 15, wherein generating the one or more model variables includes using other data associated with the entity.

24. The system of claim 23, wherein the other data includes an address, or a distance between an address and a current location.

25. The system of claim 23, wherein the other data includes a frequency of past purchases within a geographical area proximate to a current location.

26. The system of claim 23, wherein the other data includes an average amount of purchases within a geographical area.

27. The system of claim 15, wherein the current data associated with the entity is configured to be determined using a Global Positioning System.

28. A computer-program product tangibly embodied in a non-transitory machine-readable storage medium, including instructions configured to cause a data processing apparatus to:
update stored signature data using current data associated with an entity, wherein the signature data includes historic data including credit card transactions or debit card transactions associated with the entity;
generate one or more model variables using the updated signature data associated with the entity;
determine a marketing score for the entity by applying the one or more model variables to a marketing model, and wherein the marketing score indicates a likelihood that the entity will respond to an offer;
determine whether the marketing score exceeds a predetermined marketing threshold;
determine whether the entity is within a geographic area; and
based upon determining that the marketing score exceeds the predetermined marketing threshold and determining that the entity is within the geographic area, generate an indication for triggering transmission of the offer to the entity.

29. The computer-program product of claim 28, wherein the indication is configured to be generated in real time.

30. The computer-program product of claim 28, further comprising instructions configured to cause the data processing apparatus to:
determine a fraud score for the entity, wherein determining the fraud score includes applying the one or more model variables to a fraud model;
determine that the fraud score exceeds a predetermined fraud threshold; and
based upon determining that the fraud score exceeds the predetermined fraud threshold, prevent transmission of the offer to the entity.

31. The computer-program product of claim 28, further comprising instructions configured to cause the data processing apparatus to:
determine a credit risk score for the entity, wherein determining the credit risk score includes applying the one or more model variables to a credit risk model;
determine that the credit risk score exceeds a predetermined credit risk threshold; and
based upon determining that the credit risk score exceeds the predetermined credit risk threshold, prevent transmission of the offer to the entity.

32. The computer-program product of claim 28, wherein the signature data includes one or more fields that store raw transaction data associated with a select number of transactions involving the entity, and wherein the raw transaction data includes at least one of a transaction date, a transaction time, a transaction amount, a merchant category code, and merchant location data.

33. The computer-program product of claim 28, wherein generating the one or more model variables includes using other data associated with the entity.

34. The computer-program product of claim 28, further comprising instructions configured to cause the data processing apparatus to:
detect a location of the entity within the geographic area.

35. The computer-program product of claim 28, further comprising instructions configured to cause the data processing apparatus to:
transmit the offer to the entity.

36. The computer-program product of claim 28, wherein the current data associated with the entity is configured to be determined using a Global Positioning System.
